(19) United States
(12) Patent Application Publication
(10) Pub. No.: US 2014/0222773 A1
(43) Pub. Date: Aug. 7, 2014

(54) A NETWORK SYSTEM FOR GENERATING APPLICATION SPECIFIC HYPERMEDIA CONTENT FROM MULTIPLE SOURCES

(71) Applicants: Killian Levacher, Dublin (IE); Vincent Wade, Co. Dublin (IE); Seamus Lawless, Co. Wicklow (IE); Alex O'Connor, Dublin (IE)

(72) Inventors: Killian Levacher, Dublin (IE); Vincent Wade, Co. Dublin (IE); Seamus Lawless, Co. Wicklow (IE); Alex O'Connor, Dublin (IE)

(73) Assignee: TRINITY COLLEGE DUBLIN, Dublin (IE)

(21) Appl. No.: 14/125,781

(22) PCT Filed: Jun. 15, 2012
(86) PCT No.: PCT/EP2012/061440

§ 371 Date: Apr. 10, 2014

Related U.S. Application Data
(60) Provisional application No. 61/497,403, filed on Jun. 15, 2011.

(51) Int. Cl. G06F 17/30; G06F 17/22

(52) U.S. Cl. CPC G06F 17/30106; G06F 17/2235
USPC 707/706; 715/205

(57) ABSTRACT

A network system for generating application specific hypermedia content from multiple sources. The system comprises a harvesting module operable for harvesting hypermedia content on the internet from a plurality of hypermedia sources. A fragmenting module is provided which is operable for fragmenting the harvested content into discrete hypermedia fragments, wherein the hypermedia fragments have associated meta data. A data repository is provided for storing the hypermedia fragments and their associated meta data. A supply module is provided which is in communication with the data repository for supplying hypermedia fragments to the consuming applications.

### FIELD OF THE INVENTION

The present teaching relates to a network system for generating application specific hypermedia content from multiple sources. In particular, the teaching relates to harvesting existing hypermedia content on the internet, fragmenting it into discrete plug-in units and republishing the plug-in units on demand.

### BACKGROUND

Adaptive Hypermedia Systems (AHS) are known in the art for delivering dynamically adapted and personalised presentations to users by sequencing and reconfiguring pieces of information. The term hypermedia is commonly used when referring to the presentation of information in which text, video, images, audio and hyperlinks are linked to create a non-linear medium of information. Hypermedia is an extension of hypertext which allows extensive cross referencing between related sections of text and associated graphic material.

Although the benefit of delivery personalised content to users is known a major drawback of AHS results from the poor quantity of suitable content available to provide adaptivity in terms of volume, granularity, style, language and meta-data. Large amount of manual effort is currently involved in creating adequate content. Such content is traditionally authored by small groups of users, and only suits a predefined set of AHS. Alternative approaches attempt to incorporate pre-existing documents, however this solution is inadequate as it lacks the ability to control the granularity of content incorporated as typically pages in their entirety are used which maintain their original formatting. A major drawback of this approach is that the pre-existing documents are associated with a lot of diverse content such as menus, advertising etc. which makes the original content difficult to reuse within different contexts unintended by the original authors. Furthermore, obtaining useful meta-data associated with content is additionally an issue. Meta-data standards such as Learning Object Metadata (LOM) are very restrictive, field dependent and time consuming to construct.

Over the past decade, a wealth of open corpus content has emerged over the World Wide Web. However, this content is single purposed and authored for human readers. For these reasons, it is inaccessible to the adaptive community. Re-purposing this existing content for usage within adaptive systems is a challenging task mainly due to its heterogeneity. It comes in multiple languages, is associated with a large amount of boilerplate content (navigation bars, advertisement) and is only available in the form of the original document, which is too coarse grained for an AHS. In contrast with prior art arrangements, which require agreements with publishers a priori of any content publication, focusing on open-corpus content requires the ability to deal with content already published on an ad-hoc basis without necessarily any technical agreement between content publishers and consumers.

There is therefore a need for a network system for generating application specific hypermedia content from multiple sources which addresses at least some of the drawbacks of the prior art.

### SUMMARY

The present teaching relates to a network system for generating application specific hypermedia content from multiple sources, as set out in the appended claims. In particular, the teaching relates to harvesting existing hypermedia content on the internet, fragmenting it into discrete plug-in units and republishing the plug-in units on demand. By advantageously aggregating data from a plurality of sources prior to distribution to a number of discrete client devices, the present teaching reduces the volume of traffic that each of the client devices need to undertake to assemble the content for viewing. It will also be appreciated that filtering and aggregation of the data prior to delivery reduces the processing required at the discrete devices and the computational overhead can be distributed to a more computationally efficient device such as a networked server or the like.

Accordingly, a first embodiment of the teaching provides a network system as detailed in claim 1. The teaching also provides a network node as detailed in claim 44. Additionally, the teaching relates to a method as detailed in claims 45 and 47. Furthermore, the teaching relates to an article of manufacturer as detailed in claim 46. Advantageous embodiments are provided in the dependent claims.

These and other features will be better understood with reference to the followings Figures which are provided to assist in an understanding of the present teaching.

### BRIEF DESCRIPTION OF THE DRAWINGS

The present invention will now be described with reference to the accompanying drawings in which:

FIG. 1 is a diagrammatic representation of a network system.

FIG. 2 is another diagrammatic representation of a network system.

FIG. 3 is a diagram illustrating the flow of data in the network system.

FIG. 4 is a diagrammatic representation of a detail of a component of the network system of FIG. 2.

FIG. 5 is a diagrammatic representation of a detail of data processing performed by network system.

FIG. 6 is a flow diagram of a component of the network system of FIG. 2 processing data.

FIG. 7 is a diagrammatic representation of a detail of the flow diagram of FIG. 6.

### DETAILED DESCRIPTION OF THE DRAWINGS

The invention will now be described with reference to an exemplary network system for generating application specific hypermedia content from multiple sources which is provided to assist in an understanding of the present teaching.

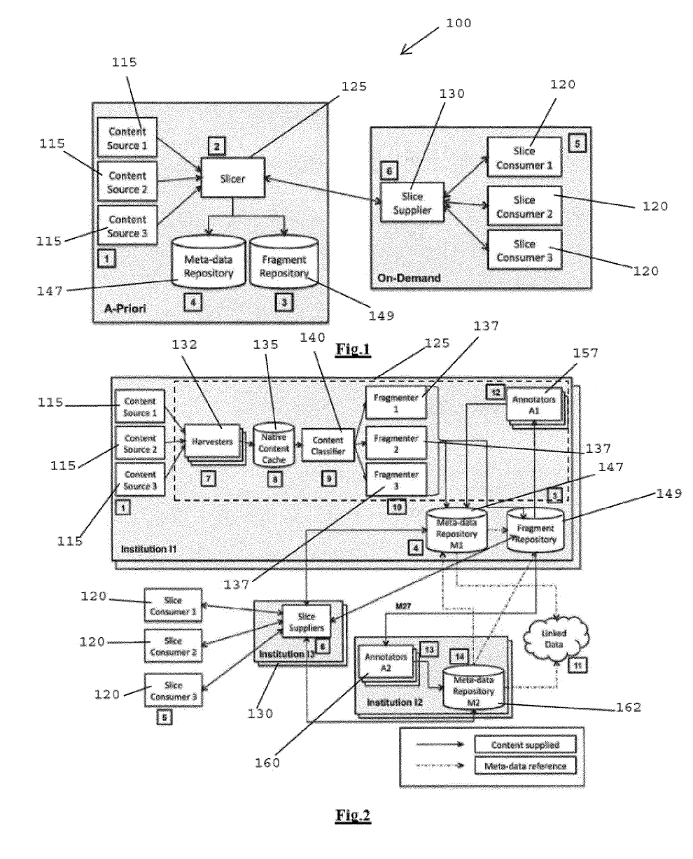

Referring initially to FIG. 1 there is illustrated a network system 100 for generating application specific hypermedia content from multiple sources. The network system 100 forms part of a distributed network which includes multiple autonomous nodes that communicate through the World Wide Web. The system 100 includes a processing module 125 which is operable to harvest existing hypermedia content available on the internet from digital sources 115 and then fragment the hypermedia content into discrete plug-in units. In the context of the present teaching the term ‘plug-in’ is intended to cover standalone segments of hypermedia content. The term ‘plug-in’ may include segments of original source code of harvested content or suitable machine readable representations thereof. The plug-in units are then supplied on demand by a supply module 130 to hypermedia consumer applications 120 that provide respective nodes in the distributed network. The supply module 130 is communicable with the hypermedia consuming applications 120 and the processing module 125 and acts as an intermediary therebetween.

The supply module 130 queries memory 147, 149 for suitable plug-in modules on behalf of the consuming applications 120. The processing module 125 includes one or more harvesting modules 132 which are operable for harvesting hypermedia content from a plurality of hypermedia sources 115. The harvested content may have associated metadata which typically provides information regarding the specifics of the content. The harvested content is typically temporarily stored in cache memory 135. One or more fragmenting modules 137 are provided for fragmenting the harvested content into discrete hypermedia fragments. The respective hypermedia fragments typically have corresponding metadata segments. The fragmenting modules may be programmed to implement any desired protocol. In an exemplary arrangement, at least two different fragmenting modules may be used to implement different protocols. The fragmenting modules 137 may operate independently, simultaneously, concurrently, or sequentially when desired.

Each hypermedia fragment is effectively a complete standalone plug-in module which is suitable for consuming by the requesting consuming software application 120 executing on a remote client device. It will therefore be appreciated by those skilled in the art that the system 100 provides ‘plug and play’ hypermedia content which are suitable for display by the applications 120 without the need for user intervention to manually format them. A classifier module 140 may be provided for classifying the harvested content for facilitating the generation of the plug-in content. The classifier module 140 augments the original metadata harvested by the harvesting module 132 with additional classification metadata. Typically, classification occurs prior to the generation of discrete hypermedia fragments. Memory is provided for storing the hypermedia fragments. In the exemplary arrangement a fragment repository 149 is provided for storing structural elements of the respective hypermedia fragments, and a metadata repository 147 is provided for storing the metadata associated with the respective hypermedia fragments. The fragment repository 149 may be used to store original segments of the source code of the harvested page or machine readable representations of segments of the original content. The metadata repository 147 may be used to store annotations referring to the segments stored in the fragment repository 149. The annotation phase of the process is described in more detail below.

The following machine readable data is an example of the type of data which may be stored in fragment repository 149:
<p> A computer is a <a href=“/wiki/Machine”>machine</a> that manipulates <a href=“/wiki/Data_(computing)” title=“Data (computing)”>data</a>according to a set of <a href=“/wiki/Code_(computer_programming)” title=“Code (computer programming)” class=“mw-redirect”>instructions</a> called a <a href=“/wiki/Computer_program”>computer program</a>. The program has an <a href=“/wiki/Execution_(computing)” title=“Execution (computing)”>executable</a> form that the computer can use directly to execute the instructions. The same program in its human-readable <a href=“/wiki/Source_code”>source code</a> form, enables a <a href=“/wiki/Programmer”>programmer</a> to study and develop the <a href=“/wiki/Algorithm#Formalization”>algorithm</a>. Because the instructions can be carried out in different types of computers, a single set of source instructions converts to machine instructions according to the <a href=“/wiki/Central_processing_unit”>central processing unit</a>type.</p>

The following data is an example of the type of information which is stored in the meta data repository 147. These examples consist of RDF triple statements written in Turtle format representing an annotation annotating the word “computer” in the previous fragment contained in repository 149 with an annotation of type 1

### Triple 1:

Meaning the previous fragment with id 5 is from the source page www.wikipedia.org:
<http://www.slicepedia.org/ontology#fragment_{—}5>
<http://www.slicepedia.org/ontology#hasSource> <http://www.wikipedia.org>.

### Triple 2:

Meaning Fragment 5 is annotated by annotation with id
http://www.slicepedia.org/ontology#Annotation_{—}12345:
<http://www.slicepedia.org/ontology#fragment_{—}5>
<http://www.slicepedia.org/ontology#hasAnnotation>
<http://www.slicepedia.org/ontology#Annotation_{—}12345>.

### Triple 3:

Meaning: Annotation with id
http://www.slicepedia.org/ontology#Annotation_{—}12345 annotates a given fragment starting at the 5th character of that fragment:
<http://www.slicepedia.org/ontology#Annotation_{—}12345>
<http://www.slicepedia.org/ontology#hasNodeStart>
<http://www.slicepedia.org/ontology#5>.

### Triple 4:

Meaning Annotation with id
http://www.slicepedia.org/ontology#Annotation_{—}12345 annotates a given fragment ending at the 14th character of that fragment:
<http://www.slicepedia.org/ontology#Annotation_{—}12345>
<http://www.slicepedia.org/ontology#hasNodeEnd>
<http://www.slicepedia.org/ontology#14>

### Triple 5:

Meaning Annotation with id
http://www.slicepedia.org/ontology#Annotation_{—}12345 is an annotation of type 1:
<http://www.slicepedia.org/ontology#Annotation_{—}12345>
<http://www.slicepedia.org/ontology#hasAnnotationType>
<http://www.slicepedia.org/ontology#Annotation_type_{—}1>.

Web pages are typically written as HTML documents consisting of a plurality of HTML elements. In general, a HTML element has three primary components—a pair of associated element tags “start tag” and “end tag”; element attributes within the start tags. Any graphical or textual content is provided between the start and end tags. The HTML element comprises of everything between and including the tags. In the exemplary embodiment a fragment may include one or more HTML elements.

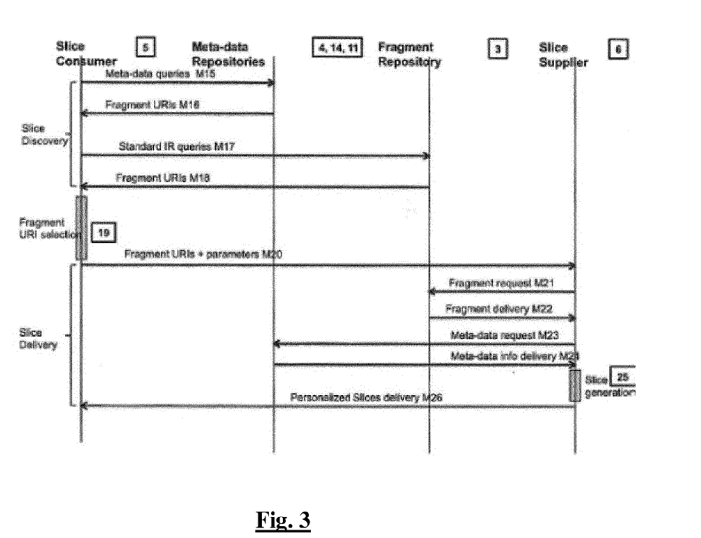

Referring now to FIG. 3, within the system 100 native content provided by a number of selected digital content sources 115 is gathered by the harvesting module 132 and converted into fragments that have associated meta-data. For example the native content may be a complete web page generated for a particular purpose, and the fragments may be individuals components of the web pages such as tables, drop down menus etc. The fragments may be considered as independent standalone plug-in content which are reusable. The content sources 115 may include but not limited to online web resources, forum content, news web sites, encyclopaedias, scanned books, private content repositories, audio files, video files, digital documents or any digital media. The harvesting module 132 operates periodically a priori of any content request from the hypermedia applications 120. In this way content may be sourced from a plurality of locations and formatted in advance of a delivery request from one or more of the hypermedia applications 120.

Once the plug-in fragments have been generated and stored in memory an on-demand phase begins. The hypermedia consuming applications 120 transmit queries to the supplier module 130 requesting specific content referred to as slices which includes a personalized package of fragments with associated annotated metadata formatted in a predefined format. The format is defined by the requesting consuming application. As a result of the queries, information is extracted from both the meta data repository 147 and the fragment repository 149 which is combined to form plug-in units/slices that are readily readable by the consuming applications 120. A consuming application can consist of any application that processes hypermedia in some form or another. Such applications 120 may include but are not limited to websites configured to re-publish content and to sophisticated AHS which are configured to manipulate the fragments into personalised presentations. The supplier module 130 receives each request from the applications 120 and selects the relevant fragments/meta-data combinations from the data repository. The supplier module 130 then transforms the latter into a set of plug-in units that meet the specific criteria of the requester and delivers copies of the plug-in units to the requesting application 120. It will therefore be appreciated that the supplier module 130 is operable to generate copies of the selected fragments which are then forwarded to the requesting consuming application 120 over the internet.

The present teaching describes both the process of fragmenting content as well as the delivery of such fragments to the applications 120. The digital sources 115 may consist of diverse publishers. The present teaching is directed to a method focused on converting particular existing open corpus material into independent reusable plug-in units. The first step involved in the method consists in harvesting targeted native content 150 to form aggregated (harvested content) content which is then temporarily cached in cache memory 135. The harvesting modules 132 may be configured to operate as web crawlers or any suitable application capable of obtaining information from web documents or digital sources. Once the required material is harvested, each harvested web document is passed through the classifier module 140 which determines the most appropriate fragmenting module 137 to perform the fragmenting step. For each web document features such as content style (news article, product page, forum content) or language among others are used as selection criteria when selecting the appropriate fragmenting module 137. This classifier module 145 identifies for instance whether each web page belongs to a previously identified group of pages with a known structure in which case a manually crafted rule-based fragmenting module 137 with high precision may be selected. If a web page consists of a news article or an encyclopaedia page a densitometric fragmenting module 137 with lower precision may be selected. It is not intended to limit the present teaching to the exemplary fragmenting modules described, it will be appreciated by those of ordinary skill in the art that any suitable fragmenting module(s) may be used.

Once the appropriate fragmenting module 137 is identified, the selected page is processed through the latter and converted into a set of coherent atomic plug-in fragments. The fragments are stored in the fragment repository 149. Each fragment within the repository 149 is assigned an unique identifier such as a uniform resource identifier (URI) by the fragment repository 149 and can be served upon a network using a suitable communication protocol such as Hypertext Transfer Protocol (HTTP). During the fragmentation step performed by the fragmenting module 137, structural meta-data that has been extracted from a native web page is inserted as resource description framework (RDF) triples within the metadata repository 147 or in another suitable storage platform such as Annotations-In-Context (ANNIC). RDF and ANNIC are provided as exemplary storage platforms, it is not intended to limit the present teaching to such platforms as alternative platforms may be employed. It will be appreciated that RDF are World Wide Web Consortium (W3C) specifications that are designed as a metadata data model. The structural meta-data may include but is not limited to the position of each fragment within the web page or whether the fragment was a forum post or not. In other words the meta-data of each fragment is identifiable by a unique URI. The metadata repository 147 may include links pointing to specific individual fragments as well as groups of fragments. The metadata repository 147 may also refer to external sources such as an ontology or linked open data.

Once the fragments are stored within the fragment repository 149, a number of processing elements termed within the present specification as annotators 157 are configured to process each fragment with the purpose of extracting more in-dept syntactic and semantic meta-data specific to each fragment. The annotators 157 may include for example part-of-speech taggers as well as passage retrieval, boilerplate detection algorithms or any suitable algorithm. The meta-data produced by the annotators 157 is added to the metadata repository 147 and is associated with existing meta-data derived from the original web pages. The meta-data generated by the annotators 157 may include links to external sources.

The content preparation pipeline of the system 100 operates a priori of any content request from the applications 120. The resulting atomic fragments and initial meta-data generated represent the foundations of fragment/meta-data correlations, which third party institutions can build upon. FIG. 2, describes, such a scenario whereby institution I2 builds upon institution I1 original fragments by processing these through its own set of annotators 160. As the choice of meta-data generated is strongly dependent upon the intended reuse of selected fragments, and as the aim consists in producing content suitable for a large range of purposes, this situation occurs whenever meta-data produced by institution I1 is inadequate for a set of applications 120. Within this scenario, institution I2 complements existing fragments with an additional set of meta-data. A set of fragments may be requested by institution I2 using the communication protocol in place and processed through its own suite of annotators 160. The resulting meta-data produced is then stored in a meta-data repository 162 provided by institution I2. The meta-data in repository 162 may be linked to the fragments stored in the fragment repository 149 as well as the metadata in the metadata repository 147.

Following page fragmentation and adequate meta-data generation, fragment requests can be processed. These requests are separated within two phases namely: i) fragment discovery and ii) fragment delivery. Within the fragment discovery phase, types of request can be sent consisting of i) meta-data queries, ii) standard information retrieval (IR) queries, or iii) a combination of both. Meta-data queries are performed on the relevant trusted meta-data repositories 147, 162 serving the metadata needed in the form of a query syntax such as SPARQL. SPARQL is an example of one of many possible query syntaxes that may be employed. Meta-data repositories 147, 162 return a list of fragment URI's meeting the meta-data requirements together with URIs identifying the meta-data instances which match the query. Standard information retrieval (IR) queries on the other hand may be sent directly to the fragment repository 149, which in turn returns the relevant fragment URIs. The query results with the appropriate fragment URIs and meta-data annotations which are then merged by the supply module 130 to form standalone plug-in units in a format that is readily readable by the requesting consuming application 120. Once the system 100 has identified the relevant fragments needed it sends the relevant fragment URIs to the supplier module 130 along with a list of parameters. These parameters can consist of a list of meta-data URIs to include with each fragment, the target granularity of fragments requested as well as the content format desired. The supplier module 130 fetches the relevant fragments from the fragment repository 149, accesses the requested meta-data using the specific URIs supplied and places these as elements within each plug-in unit. The resulting plug-in units are then delivered in the requested format to the relevant hypermedia consuming application 120. The delivered data to the hypermedia consuming applications 120 can consist of individual or combined fragments retrieved from various fragment repositories 149.

In the exemplary embodiment the supply module 130 includes a search engine operable for searching hypermedia fragments stored in the data repository. The supply module 130 may be operable to score the search hits of the search engine. For example, the supply module 130 may be operable to score the search hits based on classification data associated with the hypermedia fragments. The supply module 130 may be configured to score the search hits based on particulars of a query received from a hypermedia consuming application 120. Advantageously, the supply module 130 is operable to select one or more hypermedia fragments stored in memory for transmitting to a hypermedia consuming application 120 based on the score. The queries received by the supply module 130 may include particulars of a node on which a hypermedia consuming application is executing. The queries may also include particulars of a remote client device on which the hypermedia consuming application is executing. The particulars of the client device may include at least one of memory criteria, visual display criteria, input/output criteria, and any suitable device criteria. The supply module 130 is operable to select data fragments stored in the data repository based on at least one of memory criteria, visual display criteria, and input/output criteria of the client device. Advantageously, the supply module 130 is operable to score the search hits based on the particulars of the node on which the hypermedia consuming application is executing. The supply module 130 may be operable for formatting the hypermedia fragments prior to transmission to the hypermedia consuming application. The supply module 130 is operable to format the fragments to a suitable format based on the query from the consuming application 120. If desired the supply module 130 is operable to transfer selected fragments to consumers without changing the formatting. The formatting may include fusing one or more hypermedia fragments together into a data packet that is suitable for being consumed by the requesting hypermedia consuming application. The data packet may include two or more hypermedia fragments which were derived from unrelated hypermedia sources. The harvesting module 132 is operable to harvest hypermedia content from a plurality of web publishers. At least some of the web publishers are operating at different network nodes. The supply module 130 is operable to publish the hypermedia fragments on the World Wide Web using a communication protocol. The supply module is operable to select one of a plurality communications protocols based on the particulars from the hypermedia consuming application. The particulars may include details about the client device on which the hypermedia consuming application is executing on.

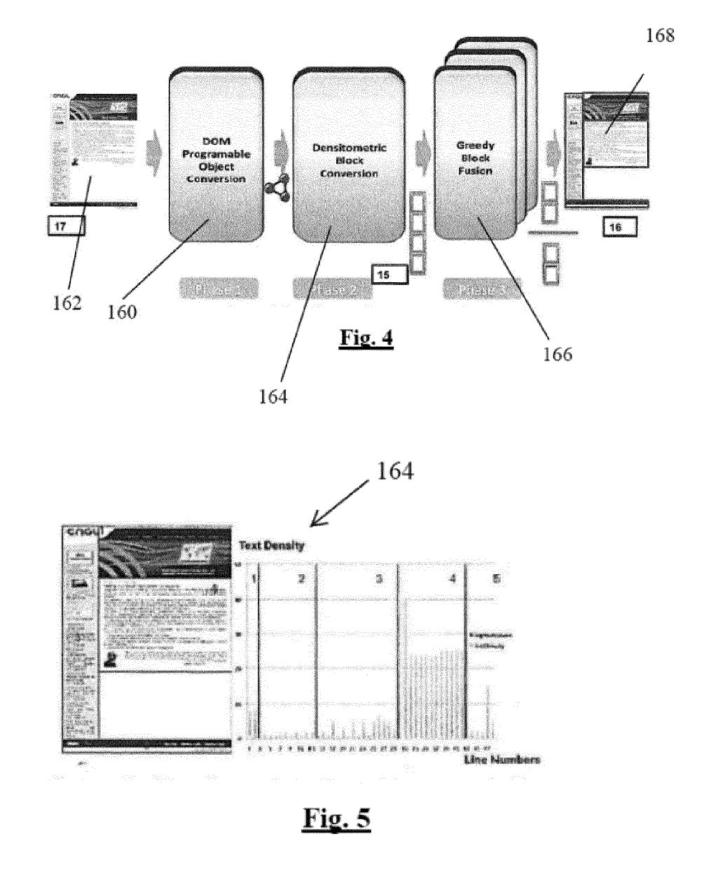

Referring now to FIGS. 4 to 7, the operation of an exemplary fragmenting module 137 is described. It is not intended to limit the present teaching to the exemplary fragmenting module. The fragmenting procedure is achieved in three phases. The first phase 160 consists in converting the xml page 162 structure into a programmable representation. Depending on the programming language been used, a set of standard libraries can be used to achieve this step. If java is selected for example, a library such as JDOM which is an open source Java-based document object model for XML may be used. The programmable representation consists of a graph mapping the original structure of the page 162. Once a programmable representation of the page 162 is available, a densitometric block conversion occurs in the second phase 164 of the procedure. The densitometric phase 164 consists in identifying individual atomic block units of a pages' structure and representing the page 162 in the form of an array populated with such blocks. In the third phase 166 of the procedure, the array is parsed and groups of atomic blocks are fused together into compounded blocks. The resulting block array 168 is then exported to a hypermedia consuming application 120 as individual fragments of the original page 162.

A densitometric analysis uses the concept of text density ρ to represent processed pages. The text density ρ(τₓ) of a tag τₓ within an xml-based document, is defined as the ratio between the number of tokens and the number of lines within τₓ and is given by the following equation:

$$ρ ( {τ}_{x} ) = \frac{\sum {Tokens}_{{τ}_{x}}}{\sum {Lines}_{{τ}_{x}}}$$

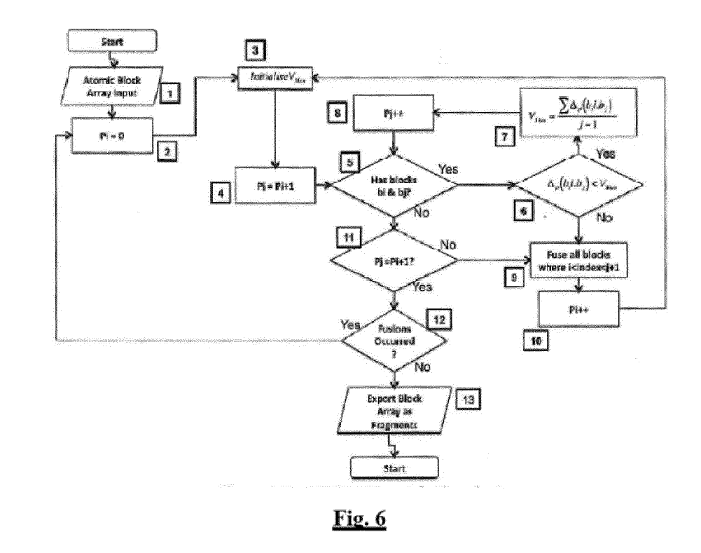

A line is defined as a word wrapping of an arbitrary character length ωₓ. If the last line of a tag has a length lower than the wrapping length ωₓ it is omitted in order to keep a correct text density value. Converting an xml-based document to a densitometric representation therefore converts a hierarchical DOM tree structure into a one dimensional representation as illustrated in FIG. 5. As can be seen in FIG. 5, sharp changes in text density correspond relatively well to desired fragmentations. Structural fragmentation using a densitometric approach therefore consists in identifying variations in text density and using these variations to identify fragment boundaries. Prior to any fragmentation however, a page must be converted to a one dimensional densitometric block array representation. Each block created at this stage, before any fusion occurs, is considered atomic and hence represents the smallest non-fragmentable unit of a page. The assumption used for a tag to be equivalent to an atomic block. Hence, any text pertaining to the same tag will be extracted within a common block. Moreover, this assumption can be fined-tuned with additional rules based on specific xml syntax. Tags, for instance, representing title elements of a page such as <h2> in html based pages can automatically be considered as one atomic block regardless of internal tags. Tags representing links on the other hand <a> in html can be ignored as atomic blocks candidates. Once a block representation of a page is available, various block fusion algorithms can be used to identify specific page fragments.

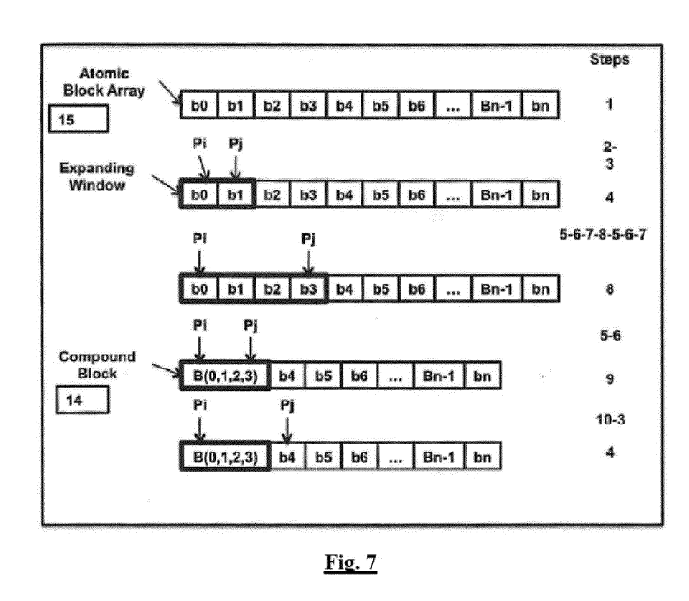

Both FIGS. 6 and 7 depict the operation of an exemplary fusion algorithm. As an input, the algorithm requires an ordered one dimensional array of atomic densitometric blocks, step 1. Pointer Pᵢ is initially set to 0, step 2, Vₘₐₓ is initialized, step 3. Pⱼ is initialized to a value equal to Pi+1, step 4. Both pointer values refer to index locations within the block array 15. If two blocks corresponding to both pointer index locations exist, step 5, the densitometric difference Δ_{ρ}(bᵢ,bⱼ) between the pair of blocks is computed and compared to a threshold value Vₘₐₓ, step 6.

$${Δ}_{ρ} ( {b}_{i} i , {b}_{j} ) = \frac{\vert ρ ( i ) - ρ ( j ) \vert}{max ( ρ ( i ) , ρ ( j ) )}$$

If Δ_{ρ} is inferior to this threshold value, the average of previous densitometric differences previously computed is assigned to Vₘₐₓ, step 7, and Pj is incremented by one, step 8. A new pair of blocks corresponding to both Pi and Pj is compared until Δ_{P}(bᵢ,bⱼ) is superior to V max. When this event occurs, all blocks with index values ranging from Pi to Pj are fused together into a new compound block with index Pi, step 9.

Pi is incremented, step 10, and the threshold value Vₘₐₓ is assigned its original value, step 3. The comparison process thereafter resumes with Pj being assigned a value Pi+1, step 4. Whenever both Pi and Pj point to out of range index values, this means one full array pass has been completed. When this event occurs, if the index value Pj is superior to Pi+1, step 11, blocks with indexes ranging from Pi and Pj are fused, step 9. In contrast, if Pj is equal to Pi+1, the algorithm checks whether any fusion occurred within this array pass, step 12. If at least one fusion did occur, Pi is initialized to 0, step 2, and the fusion process starts again. Whenever no fusion occurred in an entire pass, the resulting set of compounded blocks remaining within the array is exported as page fragments, step 13 and the algorithm stops.

It will be understood that what has been described herein is an exemplary network system for distributing hypermedia content to consuming applications. While the present teaching has been described with reference to exemplary arrangements it will be understood that it is not intended to limit the teaching to such arrangements as modifications can be made without departing from the spirit and scope of the present teaching.

It will be understood that while exemplary features of a network system in accordance with the present teaching have been described that such an arrangement is not to be construed as limiting the invention to such features. The method of the present teaching may be implemented in software, firmware, hardware, or a combination thereof. In one mode, the method is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. The steps of the method may be implemented by a server or computer in which the software modules 120, 125, 130,132, 140, 137, 147, 149, 157, 160, 162 reside or partially reside.

Generally, in terms of hardware architecture, such a computer will include, as will be well understood by the person skilled in the art, a processor, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the other computer components.

The processor(s) may be programmed to perform the functions of the modules 120, 125, 130, 132, 140, 137, 147, 149, 157, 160, 162. The processor(s) is a hardware device for executing software, particularly software stored in memory. Processor(s) can be any custom made or commercially available processor, a central processing unit (CPU), an auxiliary processor among several processors associated with a computer, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor(s) may also represent a distributed processing architecture such as, but not limited to, SQL, Smalltalk, APL, KLisp, Snobol, Developer 200, MUMPS/Magic.

Memory is associated with processor(s) and can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor(s).

The software in memory may include one or more separate programs. The separate programs comprise ordered listings of executable instructions for implementing logical functions in order to implement the functions of the modules 120, 125, 130,132, 140, 137, 147, 149, 157, 160, 162. In the example of heretofore described, the software in memory includes the one or more components of the method and is executable on a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., Android OS available from Google Inc, and Windows CE available from Microsoft Corporation). The operating system essentially controls the execution of other computer programs, such as the that provided by the present teaching, and provides scheduling, input-output control, file and data management, memory management, and communication control and related services.

The present teaching may include components provided as a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, a methodology implemented according to the teaching may be expressed as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices and components of the computer may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

When the method is implemented in software, it should be noted that such software can be stored on any computer readable medium for use by or in connection with any computer related system or method. In the context of this teaching, a computer readable medium is an electronic, magnetic, optical, or other physical device or means that can contain or store a computer program for use by or in connection with a computer related system or method. Such an arrangement can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

Any process descriptions or blocks in Figures, such as FIGS. 1 and 2 should be understood as representing modules, segments, or portions of code which include one or more executable instructions for implementing specific logical functions or steps in the process, as would be understood by those having ordinary skill in the art.

It should be emphasized that the above-described embodiments of the present teaching, particularly, any “preferred” embodiments, are possible examples of implementations, merely set forth for a clear understanding of the principles. Many variations and modifications may be made to the above-described embodiment(s) without substantially departing from the spirit and principles of the present teaching. All such modifications are intended to be included herein within the scope of this disclosure and the present invention and protected by the following claims.

Although certain example methods, apparatus, systems and articles of manufacture have been described herein, the scope of coverage of this application is not limited thereto. On the contrary, this application covers all methods, systems, apparatus and articles of manufacture fairly falling within the scope of the appended claims.

The words comprises/comprising when used in this specification are to specify the presence of stated features, integers, steps or components but does not preclude the presence or addition of one or more other features, integers, steps, components or groups thereof.

1. A network system for generating application specific hypermedia content from multiple sources for subsequent delivery to one or more remote client devices, the system comprising:
at least one harvesting module operable for harvesting hypermedia content on the internet from a plurality of hypermedia sources,
at least one fragmenting module operable for fragmenting the harvested hypermedia content into discrete hypermedia fragments, wherein the hypermedia fragments have associated meta data,
a data repository for storing the hypermedia fragments and their associated meta data, and
at least one supply module in communication with the data repository for supplying hypermedia fragments to the one or more remote client devices.

2. A network system as claimed in claim 1, further comprising cache memory for caching the harvested content.

3. A network system as claimed in claim 1, further comprising a classifier module operable for classifying the harvested content.

4-7. (canceled)

8. A network system as claimed in claim 1, wherein the supply module includes a search engine operable to
receive queries from consuming applications residing on the one or more remote client devices,
query the data repository based on the received queries, and
generate search hits from the data repository.

9. (canceled)

10. A network system as claimed in claim 8, wherein the supply module is operable to score the search hits based on classification data associated with the hypermedia fragments.

11. A network system as claimed in claim 8, wherein the supply module is operable to score the search hits based on particulars of a query received from a consuming application.

12. A network system as claimed in claim 8, wherein the supply module is operable to
select one or more hypermedia fragments stored in the data repository, and
generate a copy of the selected hypermedia fragment for forwarding to at least one of the consuming applications.

13-16. (canceled)

17. A network system as claimed in claim 1, wherein a plurality of fragmenting modules are provided wherein at least two fragmenting modules are programmed to implement different protocols.

18-22. (canceled)

23. A network system as claimed in claim 1, wherein the at least one harvesting module is operable to
harvest hypertext and
harvest hypertext sources comprising at least one of tables, images, presentational data, natural language text, mark-up language text, Standard Generalized Markup Language text, Extensible Markup Language text, metadata, and web pages.

24-29. (canceled)

30. A network system as claimed in claim 1, wherein the at least one harvesting module is operable to operate as a web crawler.

31. A network system as claimed in claim 1, wherein the at least one harvesting module is operable to harvest hypermedia content from a plurality of web publishers and
wherein at least some of the web publishers are operating at different network nodes.

32. (canceled)

33. A network system as claimed in claim 1, wherein each hypermedia fragment is assigned a uniform identifier.

34. A network system as claimed in claim 1, wherein the supply module is operable to publish the hypermedia fragments on the World Wide Web using a communication protocol.

35. (canceled)

36. A network system as claimed in claim 1, further comprising a plurality of annotators for augmenting the metadata associated with the hypermedia fragments with annotations, wherein
each hypermedia fragment is processed by a respective one of the plurality of annotators, and
the plurality of annotators are arranged in a pipeline arrangement with an output of one annotator providing an input to another annotator.

37-39. (canceled)

40. A network system as claimed in claim 36, wherein the annotator includes at least one of part-of-speech tagger, passage detection algorithm and passage retrieval algorithm.

41. A network system as claimed in claim 36, wherein the annotator is operable to produce metadata, and further wherein
the metadata produced by the plurality of annotators is linked with the metadata harvested by the at least one harvesting module, and
the metadata produced by the plurality of annotators includes links to external sources.

42. (canceled)

43. (canceled)

44. A network system as claimed in claim 1, further including a server on which the at least one harvesting module and the at least one fragmenting module reside.

45. (canceled)

46. A network node for generating application specific hypermedia content from multiple sources, the node comprising:
at least one harvesting module operable for harvesting hypermedia content on the internet from a plurality of hypermedia sources,
at least one fragmenting module operable for fragmenting the harvested hypermedia content into discrete hypermedia fragments, wherein the hypermedia fragments have associated meta data,
a data repository for storing the hypermedia fragments and their associated meta data, and
at least one supply module in communication with the data repository for supplying hypermedia fragments to consuming applications.

47. A method for generating application specific hypermedia content from multiple sources, the method comprising:
harvesting hypermedia content on the internet from a plurality of hypermedia sources,
fragmenting the harvested hypermedia content into discrete hypermedia fragments, wherein the hypermedia fragments have associated meta data,
storing the hypermedia fragments and their associated meta data, and
publishing the hypermedia fragments on demand to hypermedia consuming applications.

48. (canceled)

49. A method for generating application specific hypermedia content from multiple sources for subsequent delivery to one or more remote client devices, the method comprising:
harvesting hypermedia content on the internet from a plurality of hypermedia sources,
fragmenting the harvested hypermedia content into discrete hypermedia fragments, wherein the hypermedia fragments have associated meta data,
storing the hypermedia fragments and their associated meta data, and
supplying hypermedia fragments to the one or more remote client devices.
